(19) United States
(12) Patent Application Publication
(10) Pub. No.: US 2003/0033130 A1
(43) Pub. Date: Feb. 13, 2003

(54) Method and system for simulating processing condition of sample

(76) Inventors: Tsutomu Hara, Fujisawa (JP); Koichi Kimura, Kamakura (JP); Akira Kagoshima, Kudamatsu (JP); Hideyuki Yamamoto, Kudamatsu (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/946,439

(22) Filed: Sep. 6, 2001

(30) Foreign Application Priority Data
Aug. 7, 2001 (JP) 2001-239633

(51) Int. Cl. G06F 17/50

(52) U.S. Cl. 703/14

(57) ABSTRACT

A server on the Internet stores a semiconductor's working recipe and user information. Next, a user transmits, to the server, data on arbitrary working conditions. Moreover, using the data and the semiconductor's working recipe, the server executes the arithmetic-calculation, then transmitting only the arithmetic-calculation result back to the user.

### BACKGROUND OF THE INVENTION

The present invention relates to a method of determining sample processing conditions and a service system therefor. More particularly, it relates to a method of determining semiconductor manufacturing conditions by a semiconductor apparatus, and a business system for providing a service of determining the semiconductor manufacturing conditions using the Internet.

In a sample processing, for example, an etching working used for manufacturing a semiconductor, its manufacturing condition is complicated. Moreover, its manufacturing condition differs, depending on the characteristic for each manufacturing apparatus, a material of the semiconductor, the degree of precision of the working, or the like.

In the prior art, in order to employ a new semiconductor structure or a new working process, the data has been acquired under various working conditions, thereby creating the working recipe.

Also, when introducing a new etching apparatus, the examination as to whether or not the manufacturing apparatus will results in desirable working conditions has been performed as follows: Namely, a sample of the semiconductor material has been brought into the manufacturing apparatus maker, or the semiconductor apparatus has been lent out to a semiconductor manufacturing maker, thereby performing the prototype-manufacturing so as to judge the success or the failure thereof.

### SUMMARY OF THE INVENTION

In the case like the prior art, however, there has been the necessity of preparing, by an experiment or the like, enormous amounts of database and working recipe for each working condition or each semiconductor manufacturing apparatus. On account of this, when manufacturing a new semiconductor, enormous amounts of time and cost have been spent on the data acquisition for determining its conditions.

Furthermore, when purchasing a new semiconductor manufacturing apparatus, there has been the necessity of renting, before the purchase, a manufacturing apparatus of the semiconductor manufacturing maker so as to determine the success or the failure. Namely, the judgement on whether or not the new manufacturing apparatus will satisfy the desirable working conditions had to be performed using the rented appliance. This, in some cases, has made it impossible to execute sufficient information collection.

Accordingly, it is an object of the present invention to provide a sample-processing-condition determining method and a service business therefor which make it possible to completely solve the above-described problems in the prior art.

It is another object of the present invention to provide a sample-processing-condition determining method and a service business therefor which tremendously reduce such steps as the experiment and the prototype-manufacturing for determining working conditions needed for processing the sample.

It is still another object of the present invention to provide a sample-processing-condition determining method and a service business therefor which allow the success or the failure of the working to be judged while hiding highly-advanced technical information and know-how and preventing them from leaking out to the outside. Here, the highly-advanced technical information and know-how are contained in the database of the working conditions needed for processing the sample.

In order to accomplish the above-described objects, according to one aspect of the present invention, there is provided a simulation method of executing the simulation of sample processing conditions by an information processing apparatus connected to the Internet. The information processing apparatus has a function of executing the simulation of a sample processing and a data storing region for storing working data on the sample processing, provides an information publicizing area for browsing information on the Internet, receives the sample working conditions and a calculation executing instruction from a client via the Internet, executes the calculation using the simulation function of the sample processing and the data storing region, and publicizes the calculation result on the Internet.

According to one embodiment of the present invention, in the above-described simulation method, the access right to the function of executing the simulation and the access right to the data storing region are granted to only a specified client.

According to one embodiment of the present invention, in the above-described simulation method, personal information about a person who has granted the working conditions is added to data included in a region where the calculation result is displayed. The right to be able to retrieve the calculation result, or the right to browse the calculation result is granted on the basis of the personal information.

In this way, the present invention has the following configuration: The database concerning the working or the working recipe is stored into a server on the Internet. Next, a user transmits, to the server, data on arbitrary working conditions. Moreover, using the data and the database concerning the working or the working recipe, the server executes the arithmetic-calculation, then sending back to the user only the arithmetic-calculation result and the success or the failure of the result.

According to the present invention, the database of the working conditions or the working recipe needed for processing the sample is publicized via the Internet, thereby making it possible to reduce such steps as an experiment and a prototype-manufacturing for determining the working conditions.

Furthermore, the conditions needed for the working are inputted when publicizing, via the Internet, the database of the working conditions or the working recipe needed for processing the sample, and then the final result is outputted. This allows the success or the failure of the working to be judged while hiding the know-how and the technology contained in the database. Namely, while simultaneously providing the calculation result based on a simulation model using the highly-advanced technical information and know-how, it is possible to prevent the highly-advanced technical information and know-how from leaking out to the outside of the server side.

### BRIEF DESCRIPTION OF THE DRAWINGS

FIG. 1 is a system configuration diagram in an embodiment of the present invention;

FIG. 2 is a flow chart for illustrating the operation of the system in the embodiment illustrated in FIG. 1;

FIG. 3 is a diagram for illustrating an example of the entry picture;

FIG. 4 is a diagram for illustrating an example of the user registration;

FIG. 5 is a diagram for illustrating an example of the parameter-inputting picture;

FIG. 6 is a diagram for illustrating an example of the calculation status display picture;

FIG. 7 is a diagram for illustrating an alteration in the calculation result;

FIG. 8 is a diagram for illustrating an example of the calculation result picture;

FIG. 9 is a diagram for illustrating the system configuration in the prior art;

FIG. 10A is a diagram for illustrating a design flow chart on a semiconductor manufacturing maker side in the prior art; and

FIG. 10B is a diagram for illustrating a design flow chart on a semiconductor manufacturing maker side in the present invention.

### DETAILED DESCRIPTION OF THE EMBODIMENT

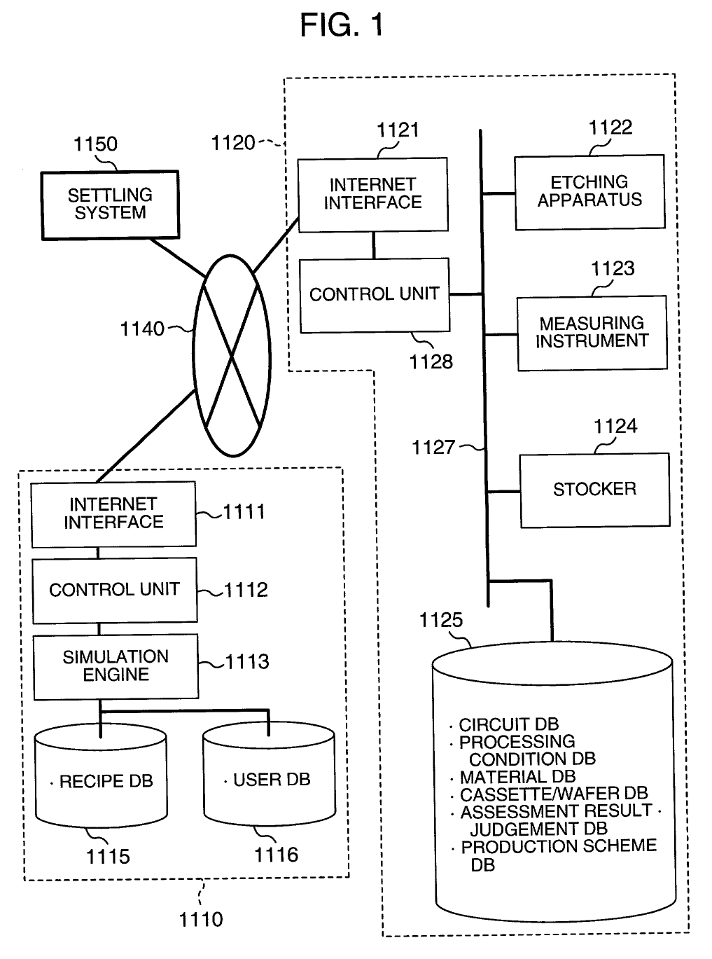

Hereinafter, based on the drawings, the explanation will be given concerning an embodiment according to the present invention of the method of determining the sample processing conditions and the service system therefor. At first, referring to FIGS. 1 to 10, the explanation will be given below regarding, as the embodiment according to the present invention, the method of determining the semiconductor manufacturing conditions and the business system for providing the service of determining the semiconductor manufacturing conditions using the Internet.

FIG. 1 illustrates the system configuration of the embodiment in the present invention. The system of this embodiment mainly includes a manufacturing system 1120 of a semiconductor manufacturer, a vacuum processing apparatus, e.g., a semiconductor apparatus 1122, a server 1110 for simulating the semiconductor manufacturing conditions, and a communications networking for connecting these components. Namely, the server 1110 is connected to the manufacturing system 1120 of the semiconductor manufacturer via the Internet 1140. Also, the server 1110 is connected to the Internet 1140 via an interface unit 1111 with the Internet. This connection eventually permits the server 1110 to execute the working and the prototype-manufacturing of a semiconductor and the assessment thereof on the basis of information obtained at an interface unit 1121. Incidentally, although a plurality of semiconductor manufacturers are connectable to the server 1110 via the Internet 1140, the explanation will be given below with one semiconductor manufacturer employed as the example for simplifying the explanation.

Here, the owner of the server 1110, i.e., a party offering a service, is assumed to be a third party that is different from the client, i.e., the semiconductor manufacturer. The owner of the server 1110 is, for example, a service company or its related company that makes a contract with a manufacturing maker of the manufacturing system 1120 and the semiconductor apparatus 1122 or with the semiconductor manufacturer so as to contract to perform the maintenance (i.e., maintenance contract) of the manufacturing system 1120. Also, the client that receives the above-described service offer is not limited to the direct user of the semiconductor manufacturing apparatus, but may be a service company that makes a contract with this user so as to contract to perform the maintenance (i.e., maintenance contract).

A settling system 1150, e.g., the server of a financial institution, for settling the cost charged for the service between the owner of the server 1110 and the semiconductor manufacturer is further connected to the Internet 1140.

The interface unit 1111 of the server 1110 has a function of providing a Web page as an information publicizing area for browsing information on the Internet. Also, the server 1110 includes a control unit 1112 for controlling the entire server 1110, a simulation engine 1113 for simulating the semiconductor manufacturing conditions, and a recipe data region 1115 for storing data on the working conditions needed for the semiconductor manufacturing. The term “recipe” refers to record information describing target conditions of the product. In addition, on the server 1110, there exists a user information's data region 1116 for storing the user information about the client (i.e., the user) that makes an access via the Internet.

The manufacturing system 1120 of the semiconductor manufacturer includes the interface unit 1121 connected to the Internet. This unit has connected the system 1120 to the Internet 1140.

The manufacturing system 1120 includes a control unit 1128 for controlling the entire system on the client side. Through a local area networking 1127, the interface unit 1121 and the control unit 1128 have been connected to the etching apparatus 1122, a measuring instrument 1123 for measuring the state of having worked the semiconductor, a stocker 1124 for stocking the semiconductor material, and a database 1125 that the semiconductor manufacturing maker owns. Also, the interface unit 1121 has a function that allows the client to transmit the working conditions and a calculation executing instruction to the simulation engine 1113 on the server 1110. Incidentally, the database 1125 has stored the following information: A semiconductor circuit state, the material information, the stocker information, the assessment result judgement conditions, the production number, the working know-how that the semiconductor manufacturing maker owns, lot history data, or the like. The lot history data is a record of recording, for example, how the processing situation has been after the semiconductor apparatus 1122 had subjected the product to the process treatment.

The semiconductor apparatus 1122 includes a transfer processing apparatus for performing the transfer of the wafer, and at least one process treatment apparatus for subjecting the wafer to an etching processing in a vacuum processing chamber in accordance with a wafer transferring schedule. Additionally, it is needless to say that the control units 1112 and 1128 include an arithmetic-calculation processing apparatus, an input/output apparatus, and a display apparatus.

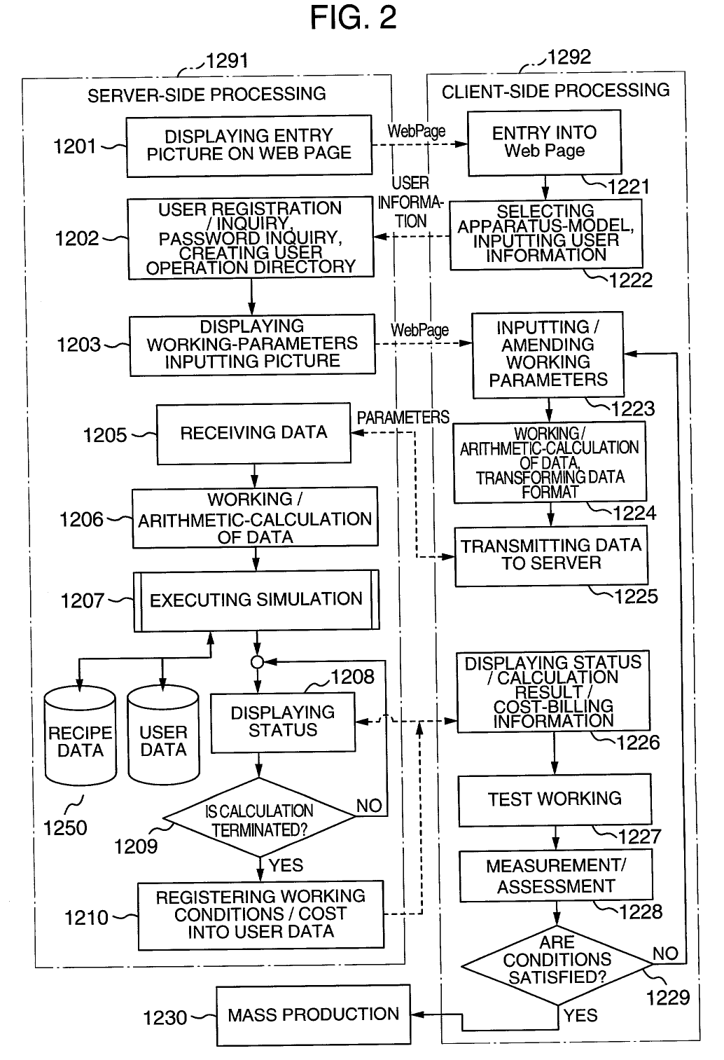

Next, referring to FIGS. 2 to 10, the explanation will be given below regarding the flow of the data in the 1st embodiment.

FIG. 2 is a schematic diagram for illustrating the flow of the data processing on the system in the 1st embodiment. In FIG. 2, the reference numeral 1291 denotes the processing on the side of the server 1110 where the control unit 1112 and the simulation engine 1113 operate as its center. Also, the reference numeral 1292 denotes the processing on the side of the client where the control unit 1128 operates as its center.

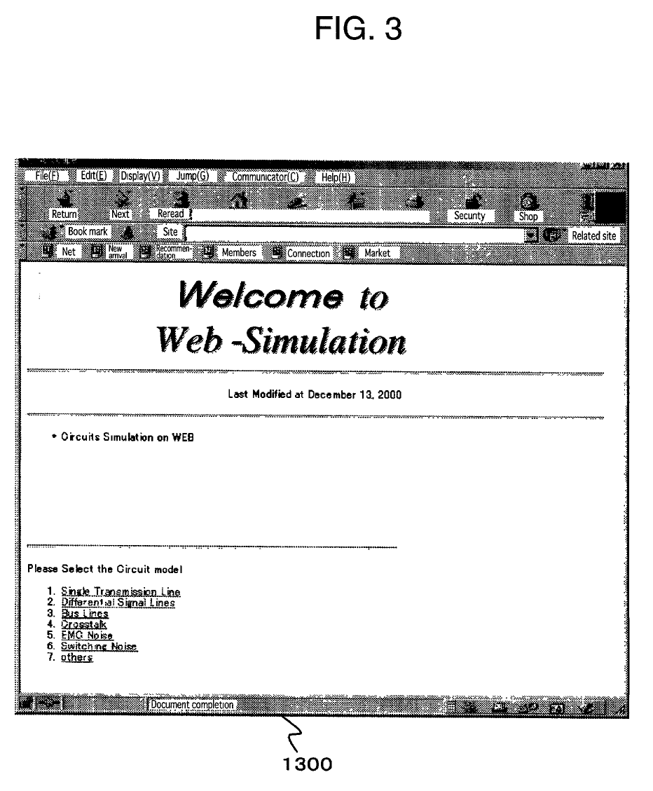

At first, in the processing 1291 on the side of the server 1110, on the interface unit 1111, an entry picture is publicized on a Web page (i.e., home page) 1300 as illustrated in FIG. 3 (step 1201). Incidentally, FIG. 3 illustrates an example where Netscape Navigator, i.e., a browser produced by Netscape Corp., has been used. In response to this, in the processing 1292 on the side of the manufacturing system 1120, an access is made to the Web page 1300 on the Internet. This makes it possible to make an entry into the environment of the present system (step 1221).

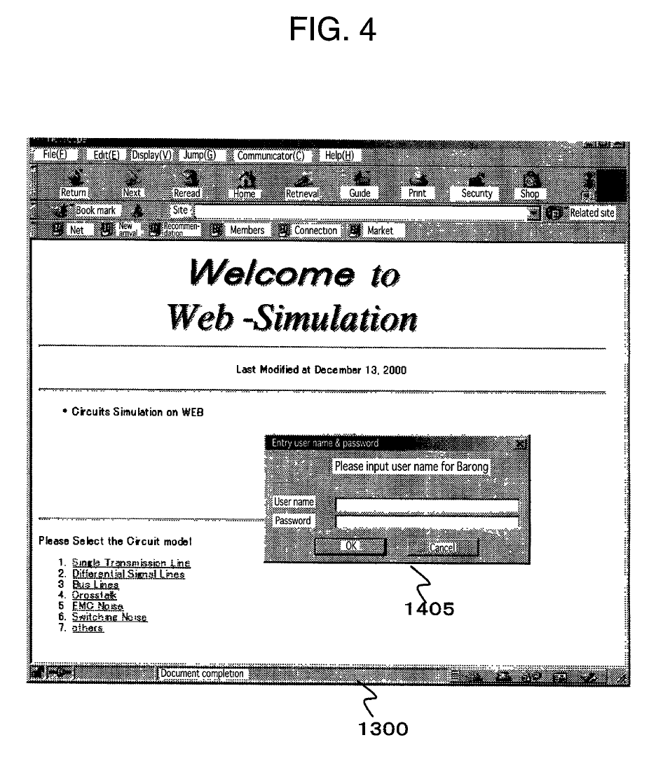

At the step of having made the entry, as illustrated in FIG. 4, the client inputs the user account and the password (step 1221). Then, the client transmits circuit-model selecting information (i.e., link-destination information), the user account, and the password to the side of the server 1110 (step 1222). The user account and the password are used when making reference to the database such as the cost-billing to the user, the type of the semiconductor manufacturing apparatus that the user owns, the characteristic inherent in the apparatus, or when browsing the data and the graph obtained as the result of the simulation.

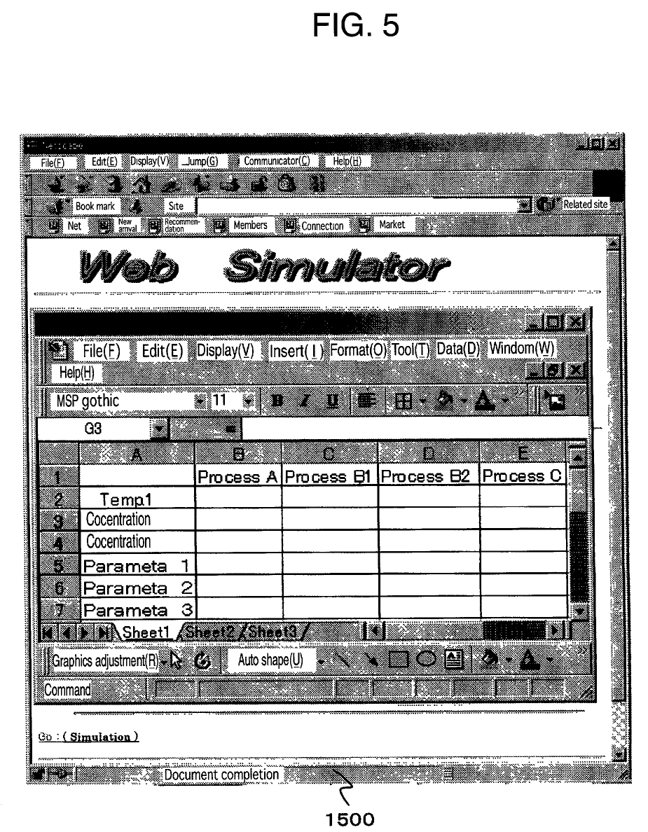

Having received the access information (i.e., the link-destination information), the user account, and the password, the server 1110 performs the user registration and the user inquiry (step 1202). After that, the server displays, on the display apparatus, a Web page 1500 which is illustrated in FIG. 5 and into which the working conditions are to be inputted (step 1203). Additionally, FIG. 5 illustrates an example where Excel, i.e., a spreadsheet software produced by Microsoft Corp., has been used.

Next, the client interactively inputs, into the Web page 1500 illustrated in FIG. 5, the conditions needed for the working such as the material information and the working environment information (step 1223). The conditions include the names of the processing steps, the number of the wafers to be processed, the film type, the film thickness, or the like. Also, the conditions include, as the etching recipe, the gas name, the gas flow-quantity, the processing pressure, the power of a plasma source, the processing time, the opened-degree of a pressure adjusting valve, or the like. Moreover, in addition to the working conditions, concerning the design and working specifications of the semiconductor as well, the inputting is performed on the present inputting picture.

After finishing the inputting of all the conditions, the client pushes a calculation executing button so as to issue a calculation executing instruction. At the step where the calculation executing instruction has been issued, the terminal on the client side executes an easily-executable calculation and data format-shaping (step 1224). After that, these data are transmitted to the server (step 1225).

The server side receives these data via the Internet (step 1205). After that, in order to cause the simulation engine 1113 to execute the simulation, the server side executes the working and the arithmetic-calculation of the data (step 1206). In addition, after the above-described operations, a starting-up command of the simulation engine 1113 is issued toward the server, thereby causing the simulation engine to execute the simulation (step 1207).

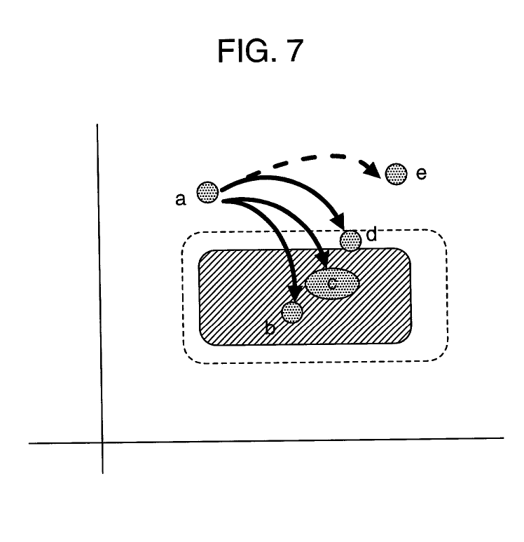

In the simulation, the calculation is executed on the basis of the following: The information on the above-described working conditions or the like inputted via the Internet, the databases 1205 (i.e., 1115, 1116 in FIG. 1) that the server side owns for storing the data on the working conditions needed for the semiconductor manufacturing, and the characteristic data of the manufacturing apparatus 1122 owned by the semiconductor manufacturer, i.e., the client that has made the access to the Web page on the interface unit 1111. In the calculation, the data are collected as a result of being classified into the following cases, depending on the working conditions: The case where the working conditions fall within the range of the design conditions (i.e., b, c in FIG. 7), the case where the working conditions fall on the boarder line of the range of the design conditions (i.e., d in FIG. 7), and the case where the working conditions fall outside the range of the design conditions (i.e., a, e in FIG. 7). Moreover, the variation information (i.e., b, c in FIG. 7) or the like generated in the working is also collected as the data.

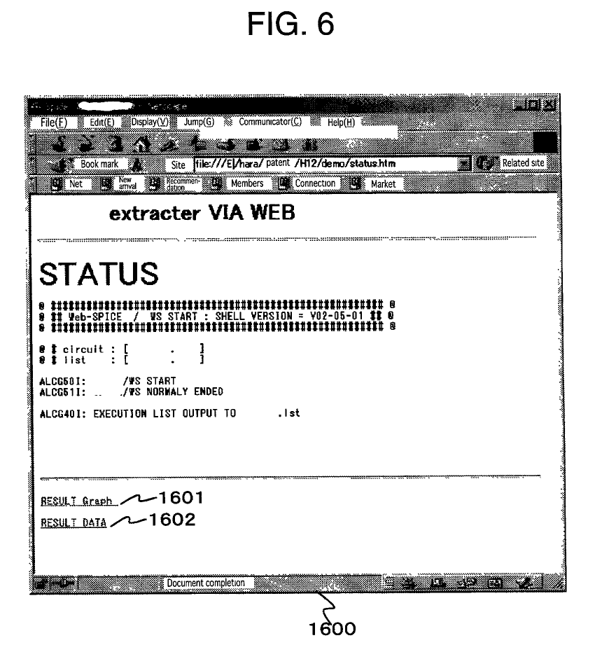

Further, in parallel to the simulation, the program executed by the control unit 1112 creates a status display picture for indicating whether or not the calculation has been executed, then displaying the status display picture on the display apparatus (step 1208). FIG. 6 illustrates what the status picture is like. The calculation status is displayed on a Web page 1600.

Still further, the control unit makes a judgement as to whether or not the simulation has been terminated, and then the control unit is on stand-by until the simulation has been terminated (step 1209).

Even further, at the step where the simulation has been terminated, the simulation result is summarized, and the data is worked so that numerical-value data of the simulation result can be registered onto the Web page (step 1210). Also, the data is worked so that an amount of the cost charged for the simulation result can also be registered onto the Web page. The cost-billing may also be executed at the time of the user registration. Otherwise, at the step (1223) where the client inputs, into the Web page, the conditions needed for the working such as the material information and the working environment information, the amount of the cost may be displayed so as to bill the cost. In this way, through the information-providing, it becomes possible for the party offering the service, i.e., the owner of the server 1110, to raise the profit.

Incidentally, the Web page 1600 illustrated in FIG. 6 for displaying the calculation status is rewritten into a page for displaying the result, thereby making it possible to display the calculation status and the calculation result with the use of a single calculation-result displaying button 1601. This allows the designer (i.e., a set maker) to cut off the terminal 1120 of the client from the system of the server 1110 during the time-period for the simulating calculation. As a result, the designer can do another job without imposing a load on the terminal 1120 of the client.

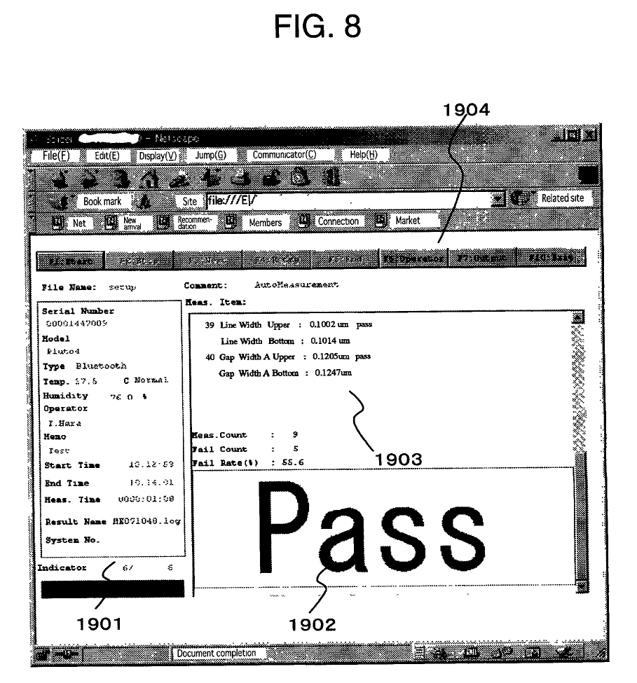

Moreover, the terminal 1120 of the client establishes a link with the Internet at an arbitrary point-in-time, thereby making it possible to fetch the numerical-value data of the simulation result as illustrated in FIG. 8 from the status picture illustrated in FIG. 6 (step 1226). Additionally, when making an access to these resultant values, it is regulated that the user name and the password be requested again. This makes it possible not only to fetch the user's own calculation result promptly but also to prevent a third party from browsing the calculation result.

FIG. 8 illustrates an example of the calculation result. In this drawing, a field 1901 on the left side displays the user information, the calculation time-period, and the cost-billing information. Also, a field 1903 displays the calculation result in the case where the calculating conditions have been inputted. A field 1902 displays a judgement result as to whether or not the calculation result satisfies the conditions. Also, with respect to the data flowing-in operations for confirming the calculating conditions and for executing a test working, the selection of a button 1904 makes it possible to jump to a link-destination, or to save the calculating conditions in a file as the working-conditions data (i.e., CAM data).

Furthermore, after obtaining the calculation result (step 1226), the user executes the test working on the basis of the obtained conditions (step 1227). In this test working, the numerical-value data are automatically extracted from the Internet interface 1121 in FIG. 1 so as to transmit the data to the control unit 1128, thereby controlling the etching apparatus 1122 automatically. Incidentally, in this operation, it is allowable to input and work the data manually. Next, using the measuring instrument (i.e., 1128 in FIG. 1), the measurement is performed concerning whether or not the working conditions satisfy the specifications (step 1228). Here, in the judgement as to whether or not the working conditions satisfy the specifications (step 1229), if the specifications are satisfied, the mass production is executed (step 1230). Also, if the specifications are not satisfied in the judgement (step 1229), going back to the working-parameters inputting step (step 1223), the inputted conditions are amended, then executing the simulation again on the server side.

Also, based on the cost-billing information and utilizing the settling system 1150, the user settles the cost charged for the service.

Next, referring to FIGS. 1, 2, 9 and 10, the explanation will be given below concerning the effects of the present embodiment.

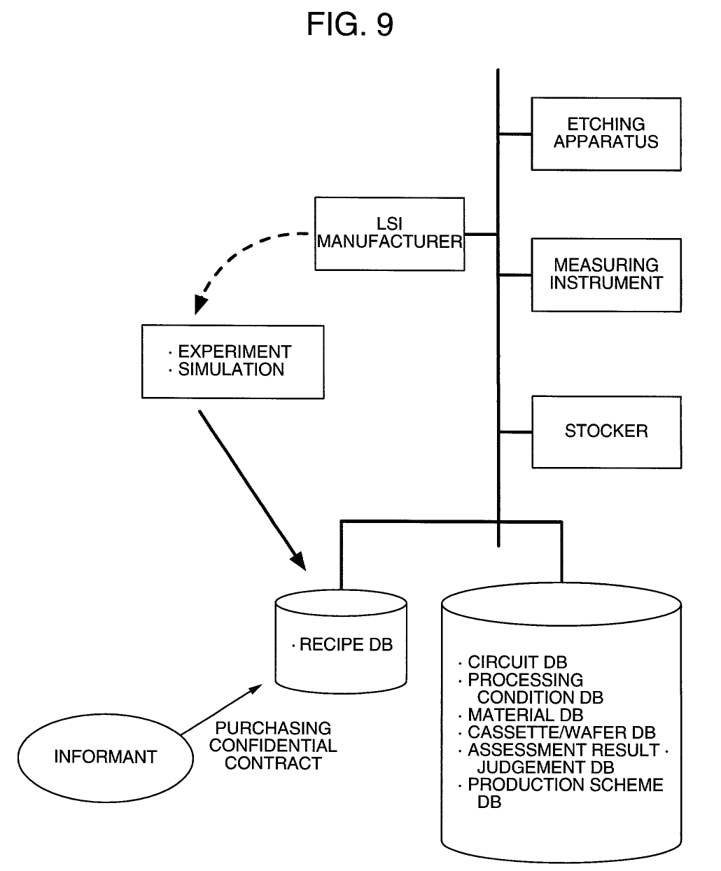

At first, referring to FIGS. 9, 10, and 1, the explanation will be given below regarding the effects seen from the semiconductor manufacturer side. FIG. 9 illustrates the designing method in the prior art. In the conventional design, as illustrated in FIG. 9, the semiconductor manufacturer side executes the experiment/simulation, thereby determining the design rules and the working conditions.

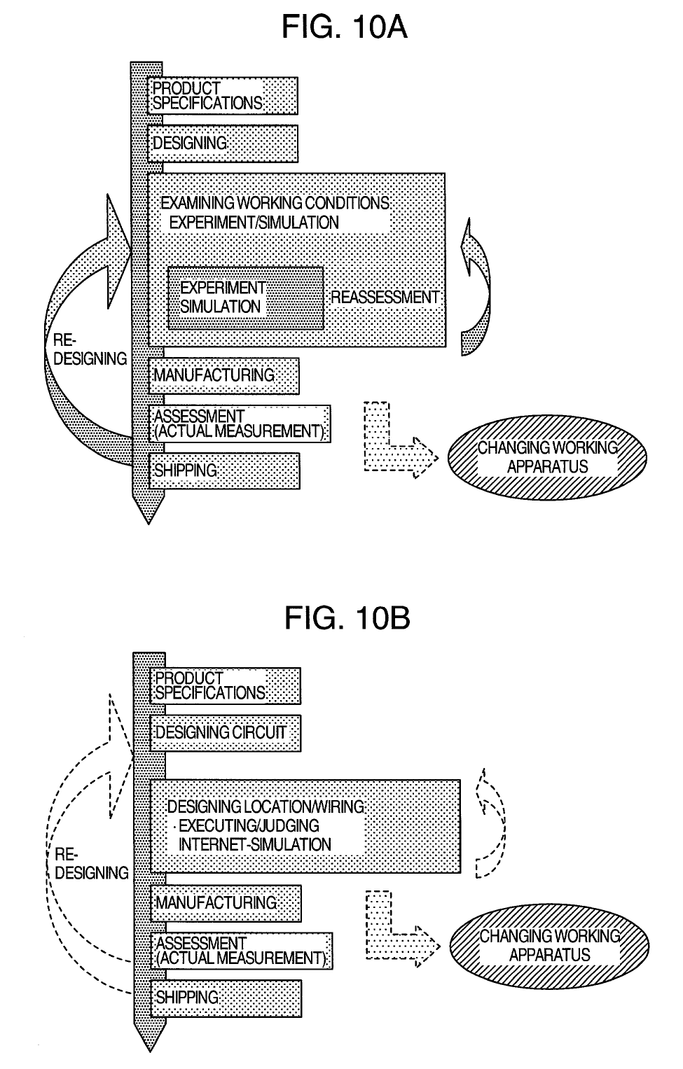

As a result of this, the semiconductor manufacturer side must execute the enormous amounts of simulation and experiment. This eventually results in a design flow as illustrated in FIG. 10A. In the conventional design, at first, after determining the product specifications of the semiconductor, examining the working conditions is executed. At this time, in order that such problems as a broken wire, a short-circuit, and a characteristic deficiency will not occur, the experiment and the simulation are performed. Here, making the working conditions suitable, selecting the working material, and designing the location/wiring are executed repeatedly, thereby creating a suitable working recipe. After that, the semiconductor is manufactured, and then the assessment by the actual measurement is performed. If the specifications are not satisfied, the design and the simulation are repeated again, and the operation similar to this is repeated until the specifications are satisfied. In order to try to shorten the designing time, it becomes required to accumulate the data based on the know-how and the fundamental experiment.

In the case where the present invention is employed, as illustrated in FIG. 10B, the present invention makes it unnecessary for the semiconductor manufacturer itself to execute the experiment, the simulation, and the redesign for the data collection. Accordingly, it becomes possible to save the enormous amounts of time and cost spent on the condition determination.

Next, the explanation will be given below concerning the effects seen from the information providing side.

As illustrated in FIG. 4, in the present embodiment, the configuration has been employed where the execution of the user registration allows the access to the information. On account of this, billing the cost at the time of the user registration makes it possible to raise the profit through the information-providing. Moreover, the simulation on the Web can be executed. This, even if there exists no semiconductor manufacturing apparatus, allows the success or the failure of the working to be judged without lending the semiconductor manufacturing apparatus. In this way, by providing the simulation environment based on the Web, it becomes possible to promote the sales of the apparatus.

Also, in the present invention, the following configuration has been employed: The server receives the information on the working conditions from the semiconductor manufacturer so as to execute the calculation utilizing the database included in the server, then returning only the calculation result back to the semiconductor manufacturer. This makes it possible to make the database itself non-public which contains the know-how and the technology, thereby being able to hide the know-how and the technology themselves of the informant.

Furthermore, by adding, to the server side, a function of counting the access situation of each manufacturing apparatus and a function of recording the working conditions, it becomes possible to obtain information on the tendency in the working conditions by the client.

Incidentally, as the semiconductor manufacturing apparatus becoming the target of the simulation, whatever apparatus is allowable as long as it is an apparatus for executing the process treatments of the wafer such as an etching, a post-processing, a film-forming, a sputtering, a CVD, and a water-processing. Otherwise, the semiconductor manufacturing apparatus may be a sample manufacturing apparatus for manufacturing a sample other than the semiconductor, e.g., a liquid crystal. Also, in response to the needs of the user, the following plurality of programs are prepared for the simulation engine so that the user can make the selection appropriately: A program created specifically for a specific apparatus included in the semiconductor manufacturing system, a program created specifically for the entire production line including a large number of semiconductor manufacturing apparatuses, a program where the attention is focused on the types of the processes, or the like.

In the present invention, the database of the working recipe is registered onto the server connected to the Internet, and only the calculation result is transferred to the party executing the simulation. This allows the semiconductor manufacturer to save the time and the cost spent on an in-advance experiment and the simulation for determining the working conditions in advance.

Also, eventually, the database of the working recipe is not directly disclosed to the semiconductor manufacturer side, but only the calculation result is disclosed thereto. This makes it possible to implement the profit-raising and the service-offering based on the information-publicizing while preventing the semiconductor manufacturer side from analyzing the data unfairly. Also, while simultaneously providing the calculation result based on a simulation model using the highly-advanced technical information and know-how, it is possible to prevent the highly-advanced technical information and know-how from leaking out to the outside of the server side.

What is claimed is:

1. A simulation method of executing a simulation of a sample processing condition by an information processing apparatus connected to the Internet, comprising the steps of:
setting up, in said information processing apparatus, a function of executing said simulation of said sample processing and a data storing region for storing working data on said sample processing;
providing, on said Internet, an information publicizing area for browsing information; receiving said sample working condition and a calculation executing instruction from a client via said Internet;
executing said calculation using said simulation function of said sample processing and said data storing region; and
publicizing a calculation result on said Internet.

2. The simulation method as claimed in claim 1, wherein an access right to said function of executing said simulation and an access right to said data storing region are granted to only a specified client.

3. The simulation method as claimed in claim 1, further comprising the steps of:
adding, to data included in a region where said calculation result is displayed, personal information on a person who has granted said working condition; and
granting, based on said personal information, a right to be able to retrieve said calculation result, or a right to browse said calculation result.

4. The simulation method as claimed in claim 1, wherein data included in a region where said calculation result is displayed includes a calculating time and cost-billing information.

5. The simulation method as claimed in claim 1, wherein, when receiving said data on said sample working condition in said step of receiving said data on said sample working condition from said client via said Internet, said data are collected as a result of being classified depending on said working condition into a case where said working condition falls within a design condition, a case where said working condition falls on a boarder line thereof, and a case where said working condition falls outside said design condition.

6. The simulation method as claimed in claim 1, further comprising the step of utilizing a Web page so as to bill a cost to said client-side terminal at a stage where said simulation has been terminated.

7. The simulation method as claimed in claim 1, further comprising the step of utilizing a Web page so as to bill a cost to said client-side terminal at a stage where said client inputs, onto said Web page, information on conditions such as material and working environment needed for said working.

8. The simulation method as claimed in claim 1, further comprising the step of utilizing a Web page so as to bill a cost to said client-side terminal at a stage where said client executes a user registration.

9. A simulation method of executing a simulation of a sample processing condition by a server connected to the Internet, comprising the steps of:
storing a working recipe of said sample and user information into said server;
transmitting an arbitrary working condition on said sample processing from a client-side terminal to said server; and
executing, in said server, an arithmetic-calculation with use of said data and said working recipe of said sample, and transmitting only an arithmetic-calculation result back to said client-side terminal.

10. A simulation method of executing a simulation of a sample processing condition by starting-up a simulation engine of a server from a client-side terminal connected to said server via the Internet, comprising the steps of:
utilizing an information publicizing area so as to transmit an arbitrary working condition on said sample processing from said client-side terminal to said server, said information publicizing area being provided by said server on said Internet,; and
utilizing said information publicizing area so as to receive, in said client-side terminal, only a result that has been arithmetically-calculated in said server with use of said data and a working recipe of said sample.

11. A simulation system for executing a simulation of a sample processing condition by an information processing apparatus connected to the Internet, said information processing apparatus comprising:
a function unit for providing, on said Internet, an information publicizing area for browsing information;
a function unit for executing said simulation of said sample processing; and
a data storing region unit for storing working data on said sample processing; wherein said information processing apparatus receives said working condition and a calculation executing instruction from a client via said Internet, and executes said arithmetic-calculation using said simulation function of said sample processing and said data storing region unit, and publicizes an arithmetic-calculation result on said Internet.

12. The simulation system as claimed in claim 11, wherein personal information on a person who has granted said working condition is added to data included in a region where said arithmetic-calculation result is displayed, and a right to be able to retrieve said arithmetic-calculation result, or a right to browse said arithmetic-calculation result is granted based on said personal information.

13. The simulation system as claimed in claim 11, wherein data included in a region where said arithmetic-calculation result is displayed includes a calculating time and cost-billing information.

14. The simulation system as claimed in claim 11, further comprising a settling system connected to said Internet for settling a cost charged for a service between an owner of a server and said client.

15. A simulation system for executing a simulation of a sample processing condition by an information processing apparatus connected to the Internet, comprising:
a server connected to said Internet for storing a database on a working and a working recipe and for providing, on said Internet, an information publicizing area for browsing information; and
a client-side terminal that has a function of utilizing said information publicizing area so as to transmit, to said server, data on an arbitrary working condition on said sample; wherein said server executes an arithmetic-calculation using said data, said database on said working, and said working recipe, and publicizes, on said Internet, only an arithmetic-calculation result and data on success or failure of said result.
